(19) United States
(12) Patent Application Publication
(10) Pub. No.: US 2025/0157080 A1
(43) Pub. Date: May 15, 2025

(54) SYSTEMS AND METHODS FOR IMAGE BASED MAPPING AND NAVIGATION

(71) Applicant: NEW YORK UNIVERSITY, New York, NY (US)

(72) Inventors: John-Ross Rizzo, New York, NY (US); Chen Feng, Brooklyn, NY (US); Anbang Yang, Brooklyn, NY (US); Diwei Sheng, Brooklyn, NY (US)

(73) Assignee: NEW YORK UNIVERSITY, New York, NY (US)

(21) Appl. No.: 18/948,295

(22) Filed: Nov. 14, 2024

Related U.S. Application Data
(60) Provisional application No. 63/599,527, filed on Nov. 15, 2023.

(51) Int. Cl. G06T 7/73; G01C 21/00; G06F 16/532; G06T 17/05; G06V 20/30

(52) U.S. Cl. CPC G06T 7/74; G01C 21/3874; G06F 16/532; G06T 17/05; G06V 20/30

(57) ABSTRACT

A navigation system includes one or more processing circuits configured to process vision data of a space, generate, based on the vision data, a map of the space, receive a query image of the space, compare a feature of the query image with one or more features of the vision data to generate a comparison between the query image and the vision data, determine, based on the comparison between the query image and the vision data, a location and a direction associated with the query image within the space, associate the location and the direction associated with the query image with a position and an orientation within the map, and compute, based on the position and the orientation within the map, a path through the space to a destination.

### CROSS-REFERENCE TO RELATED PATENT APPLICATIONS

This application claims the benefit of priority to U.S. Provisional Patent Application No. 63/599,527, filed Nov. 15, 2023, which is incorporated herein by reference in its entirety.

### STATEMENT OF GOVERNMENT SUPPORT

This invention was made with government support under grant number 20-A0-00-1004369 awarded by the National Institutes of Health and grant numbers 2236097 and 2345139 awarded by the National Science Foundation. The government has certain rights in the invention.

### BACKGROUND

This application generally relates to navigating through a space. People with blindness and low vision may have difficulty travelling efficiently and safely and may have difficulty finding destinations of interest.

### SUMMARY

One embodiment relates to a navigation system. The navigation system includes one or more processing circuits configured to process vision data of a space, generate, based on the vision data, a map of the space, receive a query image of the space, compare a feature of the query image with one or more features of the vision data to generate a comparison between the query image and the vision data, determine, based on the comparison between the query image and the vision data, a location and a direction associated with the query image within the space, associate the location and the direction associated with the query image with a position and an orientation within the map, and compute, based on the position and the orientation within the map, a path through the space to a destination.

Another embodiment relates to a navigation system. The navigation system includes a first sensor configured to acquire vision data of a space, a user device including a second sensor configured to acquire a query image associated with a location and a direction that are indicative of a location and a direction of a user within the space, and one or more processing circuits. The one or more processing circuits are configured to generate, based on the vision data, a map of the space, receive, from the user device, the query image of the space, compare a feature of the query image with features of one or more reference images of the vision data to generate a comparison between the query image and the one or more reference images, determine, based on the comparison between the query image and the one or more reference images, the location and the direction associated with the query image within the space, associate the location and the direction associated with the query image with a position and an orientation within the map, and compute, based on the position and the orientation within the map, a path through the space to a destination.

Still another embodiment relates to a method for environment mapping and navigation. The method includes processing vision data of a space, generating, based on the vision data, a map of the space, comparing a feature of a query image associated with a location and a direction within the space with features of a reference image of the vision data to generate a comparison between the query image and the reference image, determining, based on the comparison between the query image and the reference image, the location and the direction associated with the query image within the space, associating the location and the direction associated with the query image with a position and an orientation within the map, and computing, based on the position and the orientation within the map, a path through the space to a destination.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a block diagram of a navigation system, according to an exemplary embodiment.

FIG. 2 is a block diagram of a control system of the navigation system of FIG. 1, according to an exemplary embodiment.

FIG. 3 is a flow diagram of a mapping, localization, and navigation process performed by the navigation system of FIG. 1, according to an exemplary embodiment.

FIGS. 4A-4C are various menus of a user interface displaying mapping information, according to an exemplary embodiment.

FIGS. 5 and 6 are flow diagrams of a localization method for localizing a user within a space, according to an exemplary embodiment.

FIGS. 7A-7C are various menus of a user interface displaying boundaries of a generated map, according to an exemplary embodiment.

FIG. 8 is an illustration of a person with blindness or low vision navigating using the navigation system of FIG. 1, according to an exemplary embodiment.

FIG. 9 is a user interface displaying an application for using the navigation system of FIG. 1, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring to the figures generally, the various embodiments disclosed herein relate to systems, apparatuses, and methods for facilitating mapping of and navigation through an environment. One exemplary embodiment of the present disclosure relates to a navigation system for building and registering a map of an environment from image data associated with a floor plan of the environment, using a visual place recognition (VPR) algorithm to find image data similar to a reference query image taken by a user (e.g., via a camera of a mobile device), localizing the user within the built map, and facilitating user navigation through the environment to a destination. The navigation system may assist a user to navigate through an environment based on their current location and orientation.

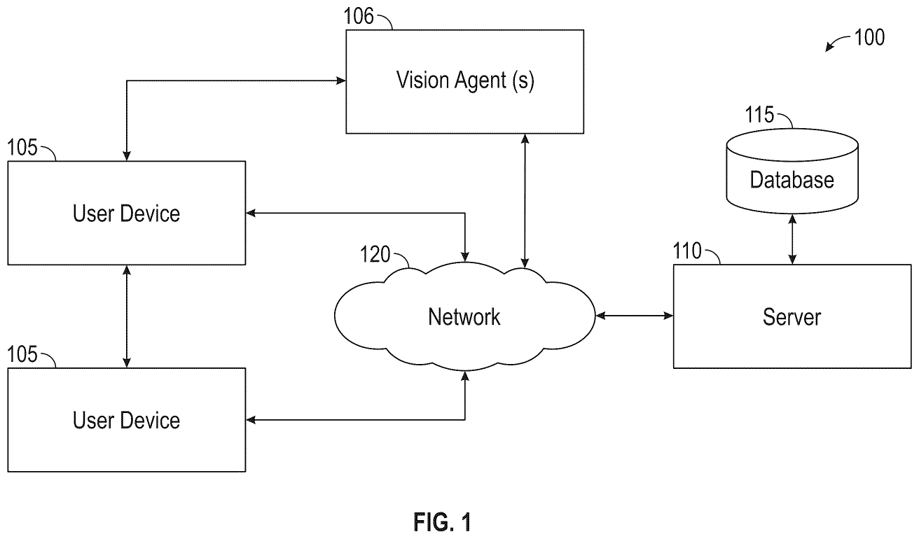

Referring to FIG. 1, a navigation system (e.g., a vision-based navigation system, a mapping system, a localization system, etc.) is shown as system 100, according to an exemplary embodiment. The system 100 is configured to generate a map of a space (e.g., house, school, office building, apartment, hospital, manufacturing plant floor, hotel, restaurant, airport, outdoor environment, etc.) based on captured image data associated with a floor plan of the space. The system 100 is further configured to localize a user within the generated map based on image data received from a user device, autonomous agent, stationary camera, and/or another vision system configured to acquire vision (e.g., image, video, point cloud, etc.) data of the space. The system 100 is further configured to provide navigation instructions to the user based on a determination of a position and orientation of the user within the map.

Referring to FIG. 1, the system 100 includes one or more user devices (e.g., smartphones, tablets, laptop computers, cameras, smart watch, wearable device, etc.), shown as user device 105, one or more vision data collection devices (e.g., aerial drones, ground vehicles, autonomous robots, autonomous dogs, robotic quadrupeds, robotic humanoids, robotic bipeds, etc.), shown as vision agents 106, one or more servers (e.g., web servers, application servers, system of servers, offsite computing system, etc.), shown as server 110, and an image database (e.g., cloud storage, memory), shown as database 115, operated by the server 110. The various components of the system 100 are in communication with each other directly and/or are connected across a network 120 (e.g., intranet, Internet, VPN, a cellular network, a satellite network, Wi-Fi, etc.). In some embodiments, the components of the system 100 communicate wirelessly. By way of example, the system 100 may utilize a cellular network, Bluetooth, near field communication (NFC), Wi-Fi, or other types of wireless communication. In other embodiments, the system 100 utilizes wired communication. The system 100 may include a networked system of servers (e.g., server 110) and wireless and/or wired components (e.g., user devices 105) operating on-premises, in the cloud, or a combination of both for redundancy. In some embodiments, the system 100 may perform one or more of the various processes and methods described herein without a connection to the network 120.

The user device 105 may be any suitable user computing device capable of accessing and communication using local and/or global networks. In some embodiments, the user device 105 includes a web browser, a mobile application, and/or another application. In some embodiments, the system 100 includes two or more user devices 105 in communication with each other. By way of example, a first user device 105 may be configured as a smartphone capable of communicating directly and/or across the network 120 with a second user device 105 configured as a wearable device capable of providing sensory feedback (e.g., haptic feedback, audio feedback, visual feedback, etc.) to a user. The user device 105 may include a user interface configured to display information to the user and receive commands from the user (e.g., by selecting buttons on a graphical user interface by touching a display screen, etc.). The user device 105 may include one or more location or environment sensors such as one or more accelerometers, gyroscopes, compasses, position sensors (e.g., global positioning system (GPS) sensors, etc.), inertial measurement units (“IMU”), audio sensors or microphones, cameras, optical sensors, proximity detection sensors, and/or other sensors to facilitate acquiring information or data regarding the location of the user device 105 and/or the surroundings thereof (e.g., to capture image data of the space).

The vision agents 106 may include or be configured as aerial drones, unmanned aerial vehicles, ground vehicles (e.g., remote controlled (RC) cars, lift devices, a personal transport vehicle, etc.), robotic quadrupeds (e.g., autonomous dogs), robotic humanoids (e.g., robots, robotic bipeds, robotic implements (e.g., actuatable arms), or the like. The vision agents 106 may include a drive system (e.g., wheels, legs, arms, propellers, motors, engines, batteries, etc.) configured to facilitate moving (e.g., propelling, steering, navigating, actuating, positioning, orienting, etc.) the vision agents 106. The vision agents 106 may include one or more location or environment sensors such as one or more accelerometers, gyroscopes, compasses, position sensors (e.g., global positioning system (GPS) sensors, etc.), inertial measurement units (“IMU”), audio sensors or microphones, cameras, optical sensors, proximity detection sensors, and/or other sensors to facilitate acquiring information or data regarding the location of the vision agents 106 and/or the surroundings thereof (e.g., to capture image data of the space). In some embodiments, the data acquired by the sensors is used to facilitate autonomous or semi-autonomous operation of the vision agents 106 (e.g., autonomous or semi-autonomous navigation and driving) and the components thereof (e.g., autonomous or semi-autonomous operation of the drive system, etc.). In some embodiments, the vision agents 106 are controlled based on an input to the user device 105 by a user. By way of example, the vision agents 106 may be deployed in a space to capture image data of the space responsive to an input from the user to the user device 105.

In some embodiments, the server 110 includes and/or is in direct communication with the database 115. In some embodiments, the system 100 includes two or more servers 110 and/or databases 115. The server 110 is configured to perform various processing capabilities related to user requests (e.g., received via the user device 105), generating responses in response to a command, and/or any other processing relating to the systems and methods described herein. The server 110 may be configured to store map information (e.g., topometric map data, 3D map data, floor plan data, etc.), image data (e.g., a database of images taken of the space, a query image, etc.), and/or computer code for completing or facilitating the various processes, layers, and modules described in the present disclosure. By way of example, the map information, image data, and/or computer code may be stored in the database 115 operated by the server 110. In some embodiments, the server 110 is a cloud computing service and/or any other offsite computing and server system. In some embodiments, the server 110 is configured to execute portions of or all of the processing relating to the system 100 and/or any method described herein. In other embodiments, the user device 105 is configured to execute portions of or all of the processing relating to the system 100 and/or any method described herein.

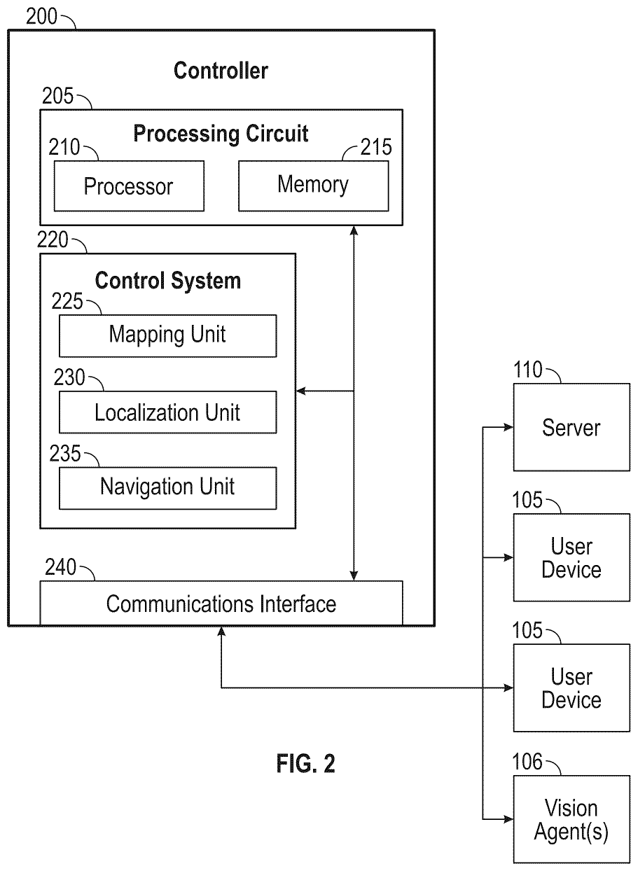

Referring now to FIG. 2, a schematic diagram of a controller 200 of the system 100 of FIG. 1 is shown according to an example embodiment. As shown in FIG. 2, the controller 200 includes a processing circuit 205 having a processor 210 and a memory device 215, a control system 220 having a mapping unit 225, a localization unit 230, and a navigation unit 235, and a communications interface 240. Generally, the controller 200 is structured to build and register a map of a space from image data received from the server 110 (e.g., via the communications interface 240) associated with a floor plan of the space, use a VPR algorithm to find image data similar to a reference query image taken by a user (e.g., via a camera of the user device 105), localize the user within the built map, and generate outputs for the user device 105 (e.g., via the communications interface 240) to facilitate user navigation through the space to a destination.

In one configuration, the mapping unit 225, the localization unit 230, and the navigation unit 235 are embodied as machine or computer-readable media that is executable by a processor, such as processor 210. As described herein and amongst other uses, the machine-readable media facilitates performance of certain operations to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). The computer readable media may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

In another configuration, the mapping unit 225, the localization unit 230, and the navigation unit 235 are embodied as hardware units, such as electronic control units. As such, the mapping unit 225, the localization unit 230, and the navigation unit 235 may be embodied as one or more circuitry components including, but not limited to, processing circuitry, network interfaces, peripheral devices, input devices, output devices, sensors, etc. In some embodiments, the mapping unit 225, the localization unit 230, and the navigation unit 235 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the mapping unit 225, the localization unit 230, and the navigation unit 235 may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on). The mapping unit 225, the localization unit 230, and the navigation unit 235 may also include programmable hardware devices such as field programmable gate arrays, programmable array logic, programmable logic devices or the like. The mapping unit 225, the localization unit 230, and the navigation unit 235 may include one or more memory devices for storing instructions that are executable by the processor(s) of the mapping unit 225, the localization unit 230, and the navigation unit 235. The one or more memory devices and processor(s) may have the same definition as provided below with respect to the memory device 215 and processor 210. In some hardware unit configurations, the mapping unit 225, the localization unit 230, and the navigation unit 235 may be geographically dispersed throughout separate locations in the system 100 (e.g., a first user device 105, a second user device 105, the server 110, etc.). Alternatively and as shown, the mapping unit 225, the localization unit 230, and the navigation unit 235 may be embodied in or within a single unit/housing, which is shown as the controller 200.

In the example shown, the controller 200 includes the processing circuit 205 having the processor 210 and the memory device 215. The processing circuit 205 may be structured or configured to execute or implement the instructions, commands, and/or control processes described herein with respect to the mapping unit 225, the localization unit 230, and the navigation unit 235. The depicted configuration represents the mapping unit 225, the localization unit 230, and the navigation unit 235 as machine or computer-readable media. However, as mentioned above, this illustration is not meant to be limiting as the present disclosure contemplates other embodiments where the mapping unit 225, the localization unit 230, and the navigation unit 235, or at least one circuit of the mapping unit 225, the localization unit 230, and the navigation unit 235, is configured as a hardware unit. All such combinations and variations are intended to fall within the scope of the present disclosure.

The hardware and data processing components used to implement the various processes, operations, illustrative logics, logical blocks, modules and circuits described in connection with the embodiments disclosed herein (e.g., the processor 210) may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, or state machine. A processor also may be implemented as a combination of computing devices, such as a combination of a DSP and a microprocessor, a plurality of microprocessors, one or more microprocessors in conjunction with a DSP core, or any other such configuration. In some embodiments, the one or more processors may be shared by multiple circuits (e.g., the mapping unit 225, the localization unit 230, and the navigation unit 235 may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The memory device 215 (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory device 215 may be communicably connected to the processor 210 to provide computer code or instructions to the processor 210 for executing at least some of the processes described herein. Moreover, the memory device 215 may be or include tangible, non-transient volatile memory or non-volatile memory. Accordingly, the memory device 215 may include database components, object code components, script components, or any other type of information structure for supporting the various activities and information structures described herein.

In some embodiments, the user device 105 and/or the vision agents 106 include the controller 200 and are configured to perform any of the functions or processes described herein with respect to the controller 200 locally. However, it should be understood that any of the functions or processes described herein with respect to the controller 200 may be performed by the server 110. By way of example, data collection may be performed by the user device 105 and/or the vision agents 106 including the controller 200 and data analytics may be performed by the server 110. By way of another example, data collection may be performed by the user device 105 and/or the vision agents 106 including the controller 200, a first portion of data analytics may be performed by the controller 200, and a second portion of data analytics may be performed by the server 110. By way of still another example, a first portion of data collection may be performed by the controller 200, a second portion of data collection may be performed by the server 110, and data analytics may be performed by the controller 200 and/or the server 110.

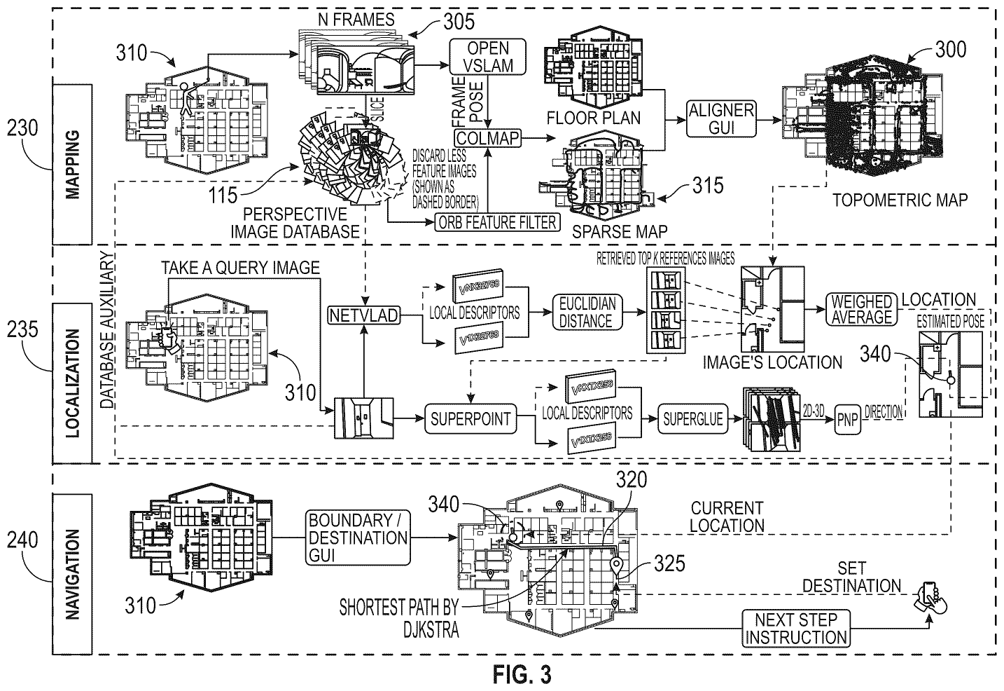

Referring to FIGS. 2 and 3, the mapping unit 225 is configured to generate a topometric map of a space based on an input (e.g., image data, sensor data, a signal, a detection, etc.) from the user device 105. In particular, the mapping unit 225 may receive and process image data of a space acquired by the sensors of the user device 105 and/or the vision agents 106. By way of example, the user device 105 may include a 360 degree field of view camera configured to record image data associated with captured images and/or captured video of the space. In some embodiments, the user device 105 include one or more sensors (e.g., visible light cameras, full-spectrum cameras, LIDAR cameras/sensors, radar sensors, infrared cameras, image sensors, LIDAR sensors, etc.) configured to acquire image data, spatial data, 3D data, etc. of a space. In some embodiments, the image data associated with captured images and/or captured video within the space may be recorded by a device other than the user device 105. By way of example, one or more stationary cameras/sensors (e.g., security cameras, motion sensors, LIDAR cameras/sensors, etc.) may be positioned throughout the space to capture the image data. By way of another example, the image data may be recorded by an autonomous drone (e.g., a vision agent 106) configured to autonomously or semi-autonomously navigate through the space. The image data collected by the user device 105 may be associated with a geolocation of where the image data was captured within the space. By way of example, a user may walk through the space while recording 360 degree field of view image data (e.g., using the user device 105) associated with a geolocation of where the image data is being captured in the space (e.g., a captured image is associated with a location of where in the space the image was captured). In some embodiments, the user may walk through the space while recording image data with a camera having a field of view that is less than 360 degrees (e.g., 120 degrees, 100 degrees, etc.). In such an embodiment, the mapping unit 225 may be configured to stitch together image data collected from two or more recordings to generate a map (e.g., the topometric map 300, the sparse map 315, etc.). The data collected by the user device 105 and/or the vision agents 106 associated with image data of the space may be stored as a reference image database by the database 115. In some embodiments, the reference image database may include image data collected from a public database accessed via the network 120. In some embodiments, the vision agents 106 and/or the one or more stationary cameras/sensors are instructed to periodically (e.g., every day, every week, every month, etc.) capture vision data of the space such that the vision data includes up-to-date and accurate data of the space (e.g., to account for dynamic changes to and arrangements of the space (as discussed in greater detail below). The user device 105 may transmit a signal (e.g., via the network 120) associated with the data collected by the user device 105 as an input to the mapping unit 225.

In some embodiments, the user device 105 is configured to provide a graphical user interface (GUI) to gamify the process/experience of acquiring image data of the space, thereby gamifying the process of building the reference image database. The GUI may be displayed on a display of the user device 105. The GUI may guide the user through a series of tasks to capture images and/or video of the space. The GUI may display a virtual map of the space, where various zones, rooms, halls, etc. are highlighted to indicate target spaces for image and/or video capture. The GUI may incorporate elements that gamify the image capture process, such as scoring points for capturing images from specific angles, capturing a sequence of images within a timeframe, accurately framing designated points within the space, etc. The GUI may include an augmented reality (AR) overlay displaying real-time image framing guidance, virtual rewards such as badges or achievement levels upon reaching milestones, and interactive notifications that provide suggestions or challenges for capturing images and/or videos within the space.

The mapping unit 225 is configured to process the vision data (e.g., image data, video data, LIDAR data, etc.) received from the user device 105 to generate a topometric map 300 of the space. In some embodiments, the mapping unit 225 utilizes one or more algorithms to process the vision data (e.g., multi-view RGB reference images) and the geolocations of the vision data (e.g., geolocation of each multi-view RGB reference image) to build a 3D sparse map (e.g., raw map, topometric map, etc.) of the space. By way of example, the mapping unit 225 may utilize a simultaneous localization and mapping (SLAM) algorithm (e.g., OpenVSLAM), a structure from motion (SfM) algorithm (e.g., Colmap), and/or any other algorithm to generate the topometric map 300 of the space. In some embodiments, the mapping unit 225 extracts a sequence of equirectangular frames 305 (e.g., images) from the vision data captured within the space. The mapping unit 225 extracts the sequence of equirectangular frames 305 such that adjacent frames (e.g., a second frame that sequentially follows a first frame over time) share a sufficient overlap of vision data of the space. Each equirectangular frame 305 from the vision data may be associated with a geolocation (e.g., 3D location) within a floor plan (e.g., a blueprint, architectural drawing, structural drawing, etc.), shown as floor plan 310 of the space. By way of example, each equirectangular frame 305 is associated with a geolocation of where the frame was captured when the user (or the vision agents 106) recorded the vision data while navigating through the space. In some embodiments, the sequence of equirectangular frames 305 (e.g., Iᵢ∈ [symbol] ^{3840×1920×3}, (i=1, 2, 3, . . . , n)) is transmitted to the mapping unit 225 as an input from the user device 105.

The mapping unit 225 may utilize the SLAM algorithm and the SfM algorithm to generate a sparse map 315 of the space containing the geolocation and a direction (e.g., orientation, etc.) of each frame of the sequence of equirectangular frames 305. In some embodiments, the sparse map 315 may be generated by the mapping unit 225 utilizing the SLAM algorithm in real-time. Utilizing the SLAM algorithm, the mapping unit 225 may slice the sequence of equirectangular frames 305 into perspective images. Each perspective image may define a predetermined width field of view and be associated with a horizontal viewing direction. In some embodiments, the sequence of equirectangular frames 305 (e.g., li) may be evenly sliced into m perspective images using the following equation:

$$m = \frac{360 °}{θ} \qquad ( 1 )$$

such that Iᵢ^{t}∈ [symbol] ^{640×360×3}, (t=1,2,3, . . . , m). In some embodiments, the horizontal viewing direction of each perspective image may be calculated using the following equation:

$${θ}_{t} = t \times θ \qquad ( 2 )$$

where θ is a view direction intersection angle between two adjacent perspective images. Collectively, the perspective images are included in a reference image database (e.g., database 115) that may be queried through and utilized by the localization unit 230 and the navigation unit 235. In some embodiments, the reference image database is stored in the database 115.

According to an exemplary embodiment, the mapping unit 225 extracts a descriptor (e.g., local descriptor, feature, pose, scale, SuperPoint feature, etc.) from each reference image and calculates a direction (e.g., orientation, pose, etc.) associated with the reference image to generate the sparse map 315 of the space. In some embodiments, the mapping unit 225 utilizes the SfM algorithm to extract the descriptor from each reference image and calculate the direction associated with the reference image to generate the sparse map 315 of the space. By way of example, the direction associated with each reference image may be calculated using the following equation:

$${α}_{i}^{t} = {α}_{i} + {θ}_{t} \qquad ( 3 )$$

where θₜ is the horizontal viewing direction of each perspective image and αᵢ is the direction associated with each frame of the sequence of equirectangular frames 305. In some embodiments, the mapping unit 225 generates the sparse map 315 of the space (e.g., using the SfM algorithm) based on the descriptor from each reference image, the direction associated with each reference image at, and the geolocation associated with each frame of the sequence of equirectangular frames 305 (e.g., the geolocation associated with each perspective image). In some embodiments, the sparse map 315 generated by the mapping unit 225 is defined in a 3D coordinate frame.

In some embodiments, the sparse map 315 generated by the mapping unit 225 is defined in a 3D coordinate frame. The mapping unit 225 is configured to project the sparse map 315 onto a two-dimensional floor plan 310 associated with the space to facilitate adding boundaries to the map such that a path through the space may be computed by the navigation unit 235. By way of example, the mapping unit 225 may be configured to associate an identified feature of each reference image with a corresponding location on the floor plan 310 (e.g., 2D-3D correspondence). The identified feature of each reference image may be associated with (e.g., include, identified by, etc.) a 3D coordinate in the sparse map 315. Because the floor plan 310 is two-dimensional, one of the coordinates may be disregarded when associating the identified feature of each reference image with a corresponding location on the floor plan 310. By way of example, each identified feature may be associated with a 3D coordinate Xᵢ=(xᵢ, yᵢ, zᵢ), where a y-axis of the sparse map 315 is perpendicular to a ground plane (e.g., a floor of the space), and because the floor plan 310 is two-dimensional, the mapping unit 225 may neglect all yᵢ coordinates from a coordinate transformation during the 2D-3D correspondence. In other words, when the sparse map 315 is viewed in a y-direction from the top (see, e.g., FIG. 3), the mapping unit 225 neglects all yᵢ coordinates from a coordinate transformation during the 2D-3D correspondence. In some embodiments, the mapping unit 225 neglects all xᵢ coordinates when the sparse map 315 is viewed in an x-direction and neglects all zᵢ coordinates when the sparse map 315 is viewed in a z-direction. In some embodiments, the mapping unit 225 may set all yᵢ coordinates to 1 and may calculate a transformation matrix using the following equation:

$$T = {{xX}^{T} ( {XX}^{T} )}^{- 1} \qquad ( 4 )$$

In such embodiments, the mapping unit 225 is configured to calculate the transformation matrix after a predetermined number of 2D-3D correspondences are identified. In such embodiments, h is the predetermined number of 2D-3D correspondences, x: [symbol] ^{2×h} is a set of 2D floor plan coordinates, X: [symbol] ^{3×h} is a set of corresponding 3D sparse map coordinates, and T= [symbol] ^{2×3} is the resulting transformation matrix. The mapping unit 225 may utilize Equation 4 to convert the 3D coordinates associated with the reference images into 2D coordinates that may be projected onto the floor plan 310 associated with the space, resulting in the topometric map 300. The topometric map 300 may define boundaries (e.g., obstacles, walls, hazards, etc.). In some embodiments, the mapping unit 225 utilizes another method or calculation to project the geolocations of each reference image onto the floor plan 310 to generate the topometric map 300.

After analyzing the reference images, the mapping unit 225 extracts descriptors from each reference image. The mapping unit 225 may compare the number of descriptors extracted from each reference image with a threshold number of descriptors. Based on the comparison, the mapping unit 225 may determine whether each reference image contains a sufficient number of descriptors to match each reference image with a query image (e.g., based on matching descriptors of the query images with descriptors of the reference images as discussed in greater detail below). In some embodiments, when the number of descriptors extracted from a respective reference image is less than the threshold number of descriptors, the mapping unit 225 determines that the respective reference image includes an insufficient number of descriptors needed to accurately match a query image therewith. In such embodiments, the controller 200 may transmit a signal to the user device 105 to provide an indication (e.g., warning, audible alert, message, etc.) that the respective reference image includes an insufficient number of descriptors. In some embodiments, the controller 200 generates suggested modifications to the space to increase the number of descriptors in a respective area of the space. By way of example, the suggested modifications may include adding décor (e.g., wall art, rugs, etc.), adding furniture (e.g., desks, couches, chairs, storage units, beds, counters, etc.), repainting walls, etc. to increase the number of descriptors in the space.

After analyzing the reference images, the mapping unit 225 extracts descriptors from each reference image. The mapping unit 225 may compare the descriptors extracted from each reference image with the descriptors of each of the other reference images do determine a similarity between reference images. In some embodiments, when a number of descriptors matched between a first reference image and a second reference image is greater than a threshold number of matched descriptors, the mapping unit 225 determines that the first reference image is substantially similar to the second reference image (e.g., even though the first reference image was captured at a first location different than a second location at which the second reference image was captured). In such embodiments, when a number of descriptors matched between a two or more reference images exceeds a threshold number of matched descriptors, the localization unit 235 (as discussed in greater detail below) may undesirably determine that a query image matches the first reference image when, in reality, the query image matches the second reference image. This incorrect localization and mapping may be referred to as perceptual aliasing, where different locations generate a similar visual or perceptual footprint. By way of example, spaces such as hospitals may include multiple locations (e.g., rooms, floors, halls, etc.) that appear the same or similar (e.g., having the same or similar floor plan, décor, etc.). In such an example, the localization unit 235 may undesirably determine that a query image matches a first reference image of a first location (e.g., a room on the first floor of the hospital) when, in reality, the query image matches a second reference image of a second location (e.g., a room on the second floor of the hospital). In some embodiments, the controller 200 is configured to transmit a signal to the user device 105 to provide an indication (e.g., warning, audible alert, message, etc.) of the reference images detecting as having similar descriptors (and could thus result in undesirable or incorrect matching by the localization unit 235). In some embodiments, the controller 200 generates suggested modifications to the space to differentiate the descriptors between locations of the space determined to be similar. By way of example, the controller 200 may suggest modifying a first location with a first type of modification (e.g., adding décor or furniture of a first type, repainting walls a first color, etc.) and modifying a second location (determined to be similar to the first location) with a second type of modification (e.g., adding décor or furniture of a second type, repainting walls a second color, etc.) different than the first type of modification to increase the differentiation between the first location and the second location.

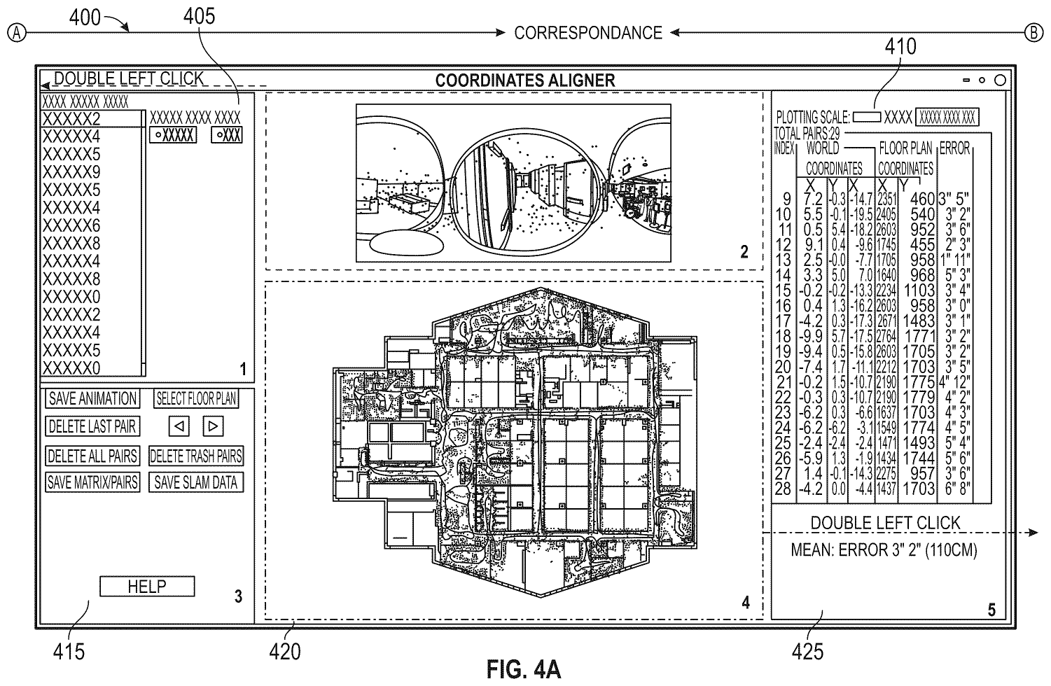

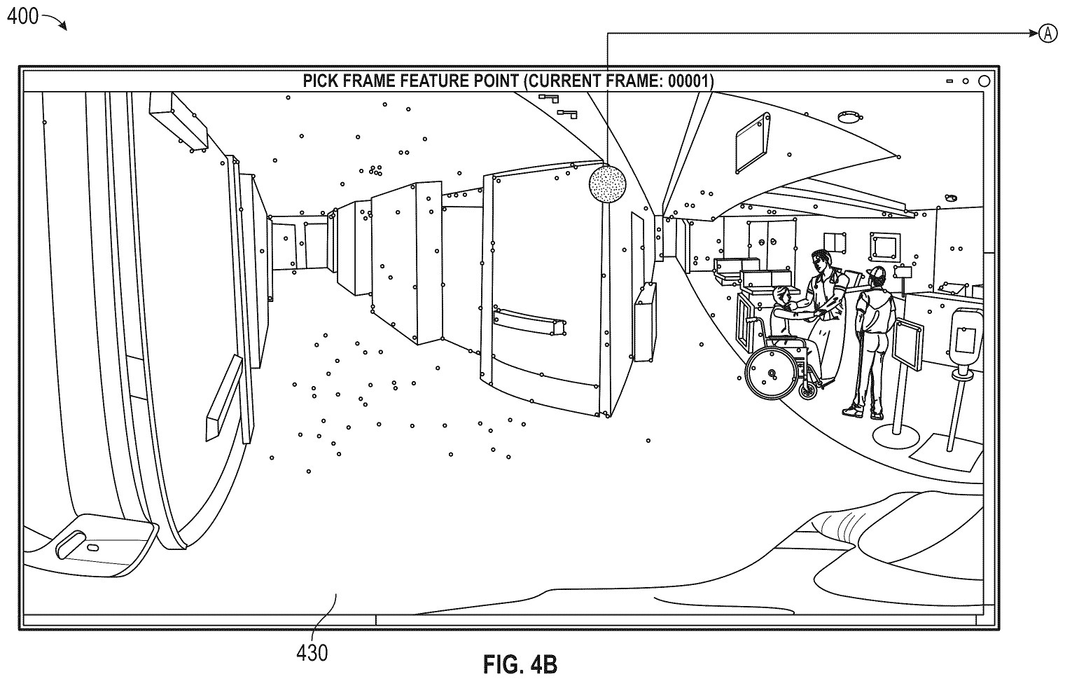

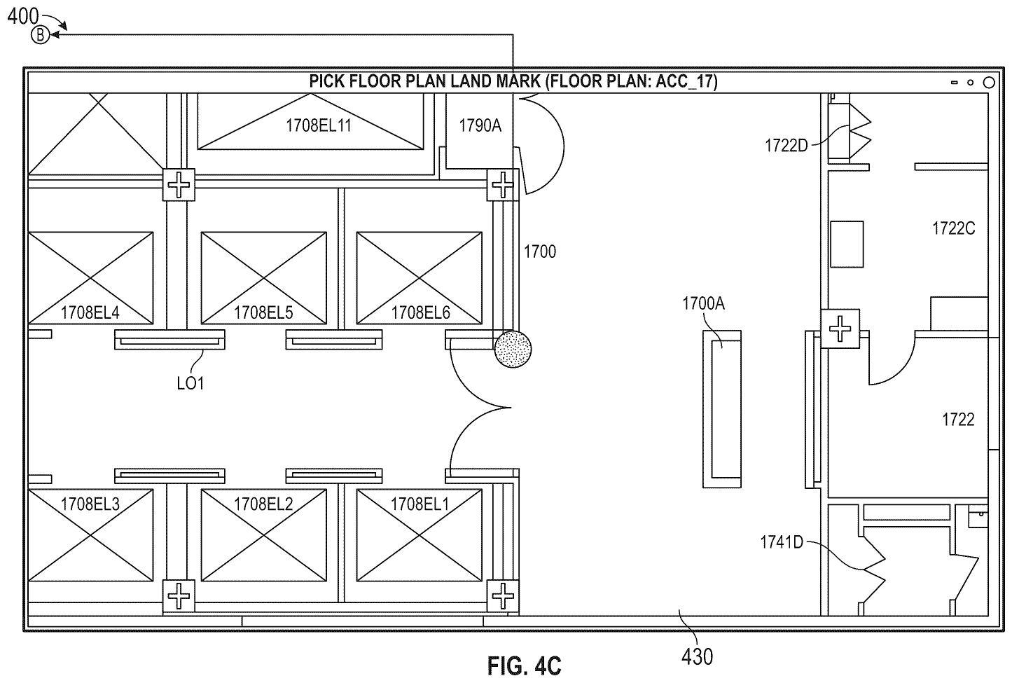

Referring to FIGS. 4A-4C, a user interface 400 is displayed. The user interface 400 includes information associated with generating the topometric map 300. The user interface 400 includes an image element 405, an image display element 410, a floor plan element 415, a floor plan display element 420, and a map error element 425. In some embodiments, a user provides inputs to the user interface 400 to manually input (e.g., identify, etc.) 2D-3D correspondences between a feature of the reference images (e.g., associated with a 3D coordinate) and a location on the floor plan (e.g., associated with a 2D coordinate). In some embodiments, the mapping unit 225 generates the information displayed in FIG. 4. In some embodiments, all equirectangular images captured by the user device 105 may be listed in the image element 405. A user may select an equirectangular image from the image element 405 to be displayed by the user interface 400 in the image display element 410. A user may upload a floor plan (e.g., floor plan 310) of the space to the mapping unit 225 and select the floor plan using the floor plan element 415. The selected floor plan may be displayed by the user interface 400 in the floor plan display element 420. In some embodiments, the user interface 400 displays the locations of all reference images and the corresponding 3D feature location on the floor plan of the floor plan display element 420. In some embodiments, the user interface 400 is configured to display the topometric map 300. In some embodiments, the map error element 425 displays information associated with an error relating to the generation of the sparse map 315 and/or the topometric map 300. In some embodiments, the user may interact with the image display element 410 and/or the floor plan display element 420 such that the user interface displays an enlarged view 430 of the equirectangular images (see, e.g., FIG. 4B) and/or the floor plan (see, e.g., FIG. 4C). In some embodiments, the user interface 400 is provided to a display device (e.g., user device 105) to be displayed thereby. The controller 200 may receive commands from the user device 105 responsive to inputs to the user interface 400 by the user (e.g., button presses, screen taps, requests to perform mapping operations, etc.).

Referring to FIGS. 2 and 3, the localization unit 230 is configured to compare a feature (e.g., descriptor) of a query image to one or more features of the reference image database, identify a network characteristic associated with the query image, and determine, based on (a) the comparison between the query image and the reference images of the reference image database and (b) the network characteristic associated with the query image, a location and a direction within the space associated with the query image. In some embodiments, a user within the space records the query image using the user device 105. By way of example, the user may take a picture of the surrounding area within the space using the user device 105 (e.g., a smartphone, a wearable device, etc.), the picture being indicative of the location and orientation of the user within the space. In some embodiments, the localization unit 230 transmits the query image to the mapping unit 225 to be included in the reference image database for analyzation in future mapping procedures performed by the mapping unit 225.

According to an exemplary embodiment, the localization unit 230 receives the query image as an input from the user device 105. In some embodiments, the localization unit 230 utilizes one or more algorithms to determine a location and an orientation of the user (e.g., the user who captured the query image, the user device 105 that captured the query image, etc.). By way of example, the localization unit 230 may utilize a visual place recognition (VPR) algorithm to retrieve one or more reference images from the reference image database determined to be similar to (e.g., visually similar to, have similar features as, etc.) the query image. In some embodiments, the localization unit 230 determines a similarity between the query image and one or more reference images by extracting one or more descriptors from the query image and comparing the one or more descriptors with one or more descriptors of one or more reference images from the reference image database. The localization unit 230 may determine the location associated with the query image within the space, and therefore the location associated with the query image that is representative of a location of the user within the space (e.g., the location of the user who captured the query image, the location of the user device 105 that captured the query image, etc.). By way of example, the localization unit 230 may be configured to average the geolocations associated with each of the one or more reference images from the reference image database determined to be similar to the query image to determine the location associated with the query image.

In some embodiments, the localization unit 230 is configured to determine the location of the query image (e.g., the user) by extracting features (e.g., global descriptors) of the query image and one or more reference images from the reference image database (e.g., utilizing NetVLAD) and calculating a Euclidean distance between them using the following equation:

$${D}_{qi} = \sqrt{{\sum }_{k = 0}^{32767} {( {d}_{qk}^{gt} - {d}_{ik}^{gt} )}^{2}} \qquad ( 5 )$$

where D_{qi} is the Euclidean distance between the global descriptor d_{qk}^{gt} of the query image and the global descriptor d′ex of the reference image. A lower Euclidean distance D_{qi} equates to a higher similarity score between the reference image and the query image. The reference images with the highest similarity K scores (e.g., the lowest Euclidean distances D_{qi}) may be selected as candidate images Iⱼ^{t} (j=1, 2, . . . K).

In some embodiments, the localization unit 230 utilizes a weighted averaging method to estimate the location of the query image using the following equation:

$$P = {\sum }_{j = 1}^{K} {ω}_{j} {P}_{j} \qquad ( 6 )$$

where P is the estimated location of the query image, Pⱼ is the location of the candidate image on the floor plan 310 within the space, and

$${ω}_{j} = \frac{{m}_{j}}{{\sum }_{k = 1}^{K} {m}_{k}}$$

is the applied weight on Pⱼ, where mⱼ and/or mₖ is the number of matched features between the query image and the associated candidate image. In some embodiments, the localization unit 230 may set mⱼ to 0 if it is not larger than 75. In some embodiments, if mⱼ of all candidate images are not larger than 75, the localization unit 230 may set the estimated location of the query image as the location of the candidate image with the largest mⱼ that is larger than 30. In some embodiments, if there is not an mⱼ larger than 30, the localization unit 230 may increase K and retry retrieval until localization unit 230 fails to estimate the location of the query image when K exceeds a threshold. In other embodiments, the localization unit 230 uses other values and/or another method to determine the location of the query image (e.g., the user).

In some embodiments, the space that was captured in the vision data (e.g., by the user device 105, the vision agents 106, the stationary cameras, etc.) changes between the moments the vision data was captured to establish the reference image database and the moment the query image is captured and analyzed by the localization unit 230. Dynamically changing spaces may include continuous or periodic changes to their physical layout, décor, and/or structural components. By way of example, such changes may include changes to furniture (e.g., desks, couches, chairs, storage units, beds, counters, etc.) placement, changes to locations of temporary walls or curtains, changes to lighting, repainting walls, adding or removing décor (e.g., wall art, plants, etc.), construction activities (e.g., demolishing walls, building walls, etc.), and/or the like. In some embodiments, when the space changes after the vision data was captured to establish the reference image database, the localization unit 230 may be unable to match, or have difficulties matching, the features of the query image with features of the reference image database (e.g., as a result of the changes to the space). By way of example, after changing the space and as a result of the changes, the localization unit 230 may calculate low similarity K scores and high Euclidean distances D_{qi} between the reference images and the query image (e.g., compared to relatively higher similarity K scores and relatively lower Euclidean distances D_{qi} if the space had remained unchanged or substantially unchanged between the moments the vision data was captured and the moment the query image was captured). By way of another example, after changing the space and as a result of the changes, the localization unit 230 may determine a relatively low number of matched features (e.g., at the same K score) between the query image and the associated candidate image (e.g., mⱼ less than 30, mⱼ less than 15, mⱼ less than 5, etc.) compared to relatively more matched features mⱼ if the space had remained unchanged or substantially unchanged between the moments the vision data was captured and the moment the query image was captured.

To account (e.g., adjust, correct, etc.) for the localization unit 230 being unable to match, or having difficulties matching, the features of the query image with features of the reference image database as a result of the changes to the space, the vision agents 106 and/or the one or more stationary cameras/sensors may be instructed (e.g., automatically instructed) to periodically (e.g., every day, every week, every month, etc.) capture vision data of the space. Increasing the frequency at which the vision data is captured (e.g., by the user device 105, the vision agents 106, and the stationary cameras/sensors) facilitates providing vision data including up-to-date and accurate data of the space to the controller 200 to be analyzed by the localization unit 230.

Additionally or alternatively to localizing the user based on the descriptors of the query image, the localization unit 230 can receive and/or identify a network characteristic (e.g., Wi-Fi signal strength, cellular signal strength, received signal strength indication (RSSI) value, network name, media access control (MAC) address, Bluetooth Low Energy (BLE) signal strength, radio frequency signal strength, strength of electromagnetic emission, etc.) associated with a network access point (e.g., Wi-Fi router, internet exchange, etc.) nearby the location of where the query image was captured as an input to determine the location within the space of where the query image was captured. By way of example, the localization unit 230 may measure a signal strength (e.g., the network characteristic) of the signals exchanged between nearby network access points and the image capture device (e.g., the user device 105, the vision agents 106, etc.) that captured the query image. The localization unit 230 may associate the query image with the signal strength at the time the query image was captured. The localization unit 230 may compare the measured signal strength with a fingerprint database including signal strength measurements, each associated with specific, known locations within the space to estimate the location of where the query image was captured (e.g., the location of the user who captured the query image, the location of the user device 105 that captured the query image, etc.). The fingerprint database may include a collection of signal strengths at various known locations within the space stored by the database 115.

During localization of the user, the localization unit 230 may utilize the VPR algorithm to retrieve one or more reference images from the reference image database determined to be similar to the query image. In some embodiments, the one or more retrieved reference images determined to be similar to the query image may be geographically dissimilar from one another within the space. By way of example, a first reference image and a second reference image may be identified, based on local descriptors, common features, etc., to be similar to the query image, but may have been captured at different locations within the space (e.g., different rooms, different corridors, different floors of the building, etc.). Accordingly, when a number of descriptors matched between the first reference image and the second reference image is greater than a threshold number of matched descriptors (as discussed in greater detail above, the localization unit 230 may localize the user and the query image based on the network characteristic thereof. In some embodiments, the VPR algorithm utilized by the localization unit 230 may compare the estimated the location of where the query image was captured, based on the network characteristic, with the geolocations associated with each of the one or more reference images from the reference image database determined to be similar to the query image to determine the location associated with the query image, thereby improving the accuracy of visual place recognition and localization of the user. By way of example, the VPR algorithm utilized by the localization unit 230 may, during localization of the user, disregard reference images determined to be similar to the query image when the localization unit 230 determines, based on the network characteristic associated with the query image, that the geolocation of the reference image is geographically dissimilar from the estimated location of the query image within the space. In some embodiments, the localization unit 230 utilizes a machine learning (e.g., deep learning) algorithm to compare the estimated the location of where the query image was captured, based on the network characteristic, with the geolocations associated with each of the one or more reference images from the reference image database determined to be similar to the query image to determine the location associated with the query image.

According to an exemplary embodiment, the localization unit 230 may utilize a perspective-n-point (PnP) algorithm to determine the orientation associated with query image (e.g., the orientation of the user who captured the query image, the orientation of the user device 105 that captured the query image, etc.). In some embodiments, the localization unit 230 utilizes the PnP algorithm to estimate the orientation associated with the query image based on the identified 2D-3D correspondences of each of the one or more reference images from the reference image database determined to be similar to the query image. By way of example, each candidate image may be associated with a 3D location of each 2D feature of the candidate image in the sparse map 315. After matching the features between the query image and the one or more candidate images, the localization unit 230 may utilize the PnP algorithm to calculate and determine one or more 2D-3D correspondences between the query image and the sparse map 315 to determine the orientation associated with query image, wherein the orientation associated with the query image is representative of an orientation of the user within the space.

In some embodiments, the localization unit 230 is configured to facilitate determining a location of an asset in the space based on the vision data and the reference image database using the methods described above to localize a user with the space. By way of example, the asset may be included in the query image taken by the user, the localization unit 230 may determine reference images that are similar to the query image, and use the known geolocations of the matched reference images to determine a location of the asset within the space. In some embodiments, the asset includes one or more sensors (e.g., cameras) configured to capture the query image and transmit the query image to the controller 200 (e.g., via the network 120) to determine the location of the asset based on the query image captured thereby.

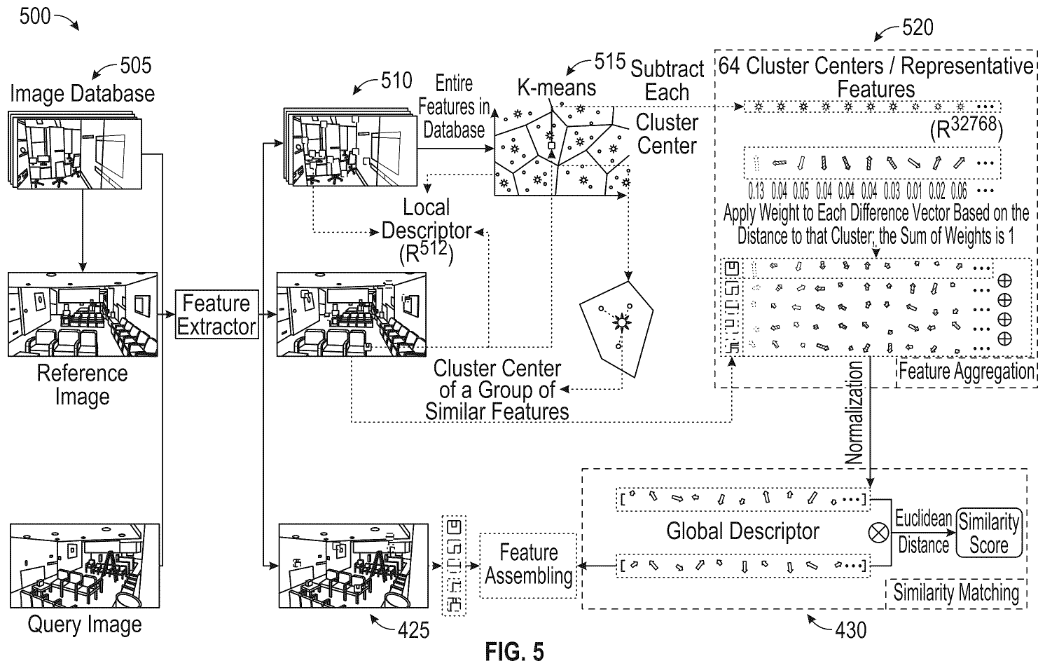

Referring to FIG. 5, a localization method 500 is shown. In some embodiments, the localization method 500 is implemented by the localization unit 230. Software implementations of the localization method 500 (e.g., via the localization unit 230) may be accomplished with standard programming techniques with rule-based logic and other logic to accomplish the various connection steps, processing steps, comparison steps, and decision steps of the localization method 500. At step 505, the reference image database and the query image are provided. At step 510, the features are extracted from the query image and from one or more reference images of the reference image database. At step 515, a local descriptor is generated that relates to information about the appearance of the feature. The local descriptor may be used to match a feature of a reference image with a feature of the query image. At step 515, a cluster is formed including groups of reference images having similar features matched based on the local descriptors. At step 520, the information from one or more matched features within the reference image database are aggregated. In some embodiments, a weighted averaging system is applied such that features and/or clusters are assigned weights based on one or more factors such as the quality of the match. At step 525, the features from the query image are assembled. At step 530, the features of the query image are compared against one or more reference images having features similar to the features in the query image, and a similarity score is calculated using a Euclidean distance equation, for example. By way of example, at step 530, local descriptors of the reference image and the query image may be assembled into global descriptors and the Euclidean distance between the global descriptor of the query image and the global descriptor of each reference image may be calculated. In such embodiments, the smaller the Euclidean distance is, the more similar the query image and the reference image is.

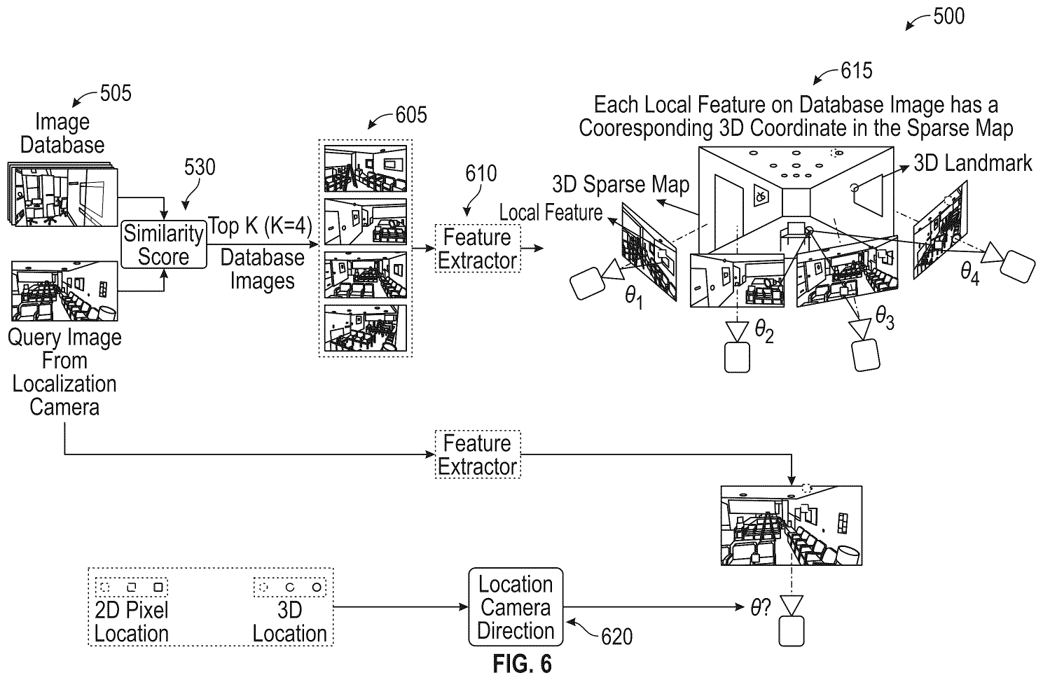

Referring to FIG. 6, the localization method 500 continues. Providing a query image at step 505, and calculating a similarity score at step 530, at step 605 the reference images with the highest matching similarity scores K are retrieved as candidate images. At step 610, similar local features between the query image and candidate images are identified. At step 615, each local feature in the candidate image is associated with a 3D location in the sparse map 315. At step 620, a set of 2D-3D correspondences between the query image and the sparse map 315 is found and the direction of the query image (e.g., the pose of the user device 105, the orientation of the user, etc.) is determined using the PnP algorithm, for example.

Referring to FIGS. 2 and 3, the navigation unit 235 is configured to compute, based on the location and the orientation associated with the query image determined by the localization unit 230, a path (e.g., route, course, line, etc.), shown as path 320, through the space to a destination, shown as destination 325 on the floor plan 310. The path 320 may include one or more straight or bent sections of routes. The navigation unit 235 may receive the location and the orientation of the query image from the localization unit 230 as an input. The navigation unit 235 may be further configured to provide instructions to a user (e.g., via audio, tactile, vibrational, etc. feedback from the user device 105) to facilitate the navigation of the user along the path 320 to the destination 325. The navigation unit 235 is configured to determine the boundaries (e.g., walls, obstacles, hazards, etc.) and the navigable areas (e.g., rooms, hallways, corridors, etc.) within the space. In some embodiments, the navigation unit 235 is configured to extract all line segments from the floor plan 310 and associate the extracted line segments with boundaries within the space, thereby creating a map of the navigable areas within the space that avoid the boundaries. In some embodiments, the navigation unit 235 is configured to determine the locations of the boundaries based on the vision data. The navigation unit 235 may utilize one or more path planning algorithms (e.g., Dijkstra's algorithm) to compute the path 320 based on the map of the navigable areas within the space. The navigation unit 235 may set a starting location and starting orientation of the path 320, shown as start 340 on the floor plan 310, to be the location and the orientation associated with the query image determined by the localization unit 230. The destination 325 may be a desired location within the space that the user wants to navigate to. The path 320 generated by the navigation unit 235 may be the shortest path through the space that avoids all boundaries from the start 340 to the destination 325. In some embodiments, the navigation unit 235 first generates a path (e.g., a first section of the path 320) to a location of a reference image that is the closest to the location of the query image, then generates the shortest path 320 (e.g., a second section of the path 320) to the destination 325.

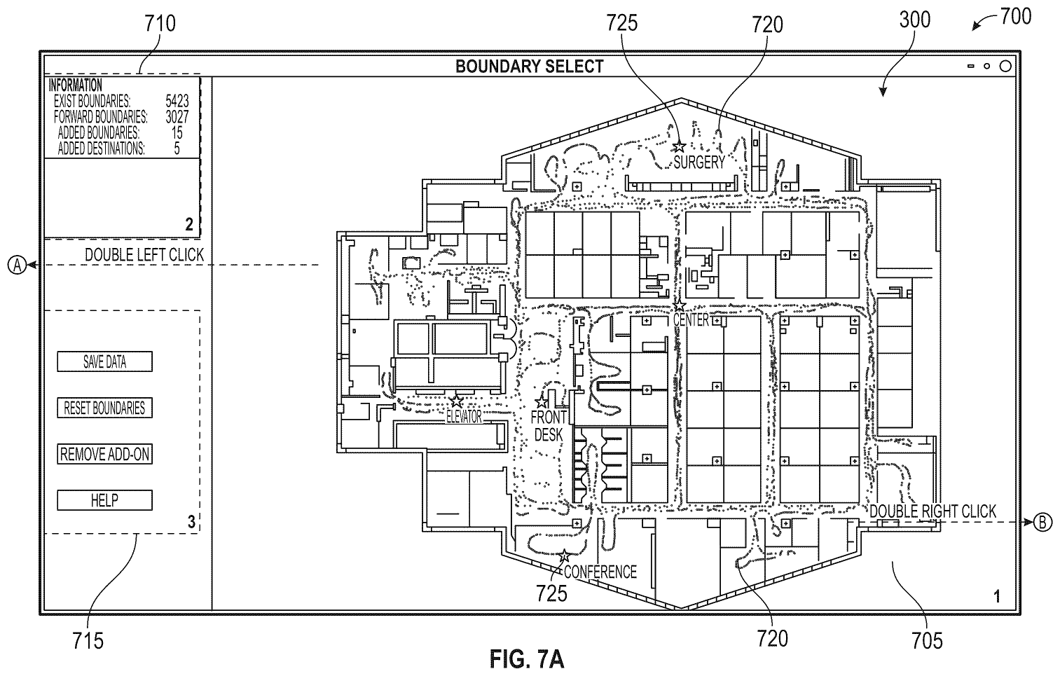

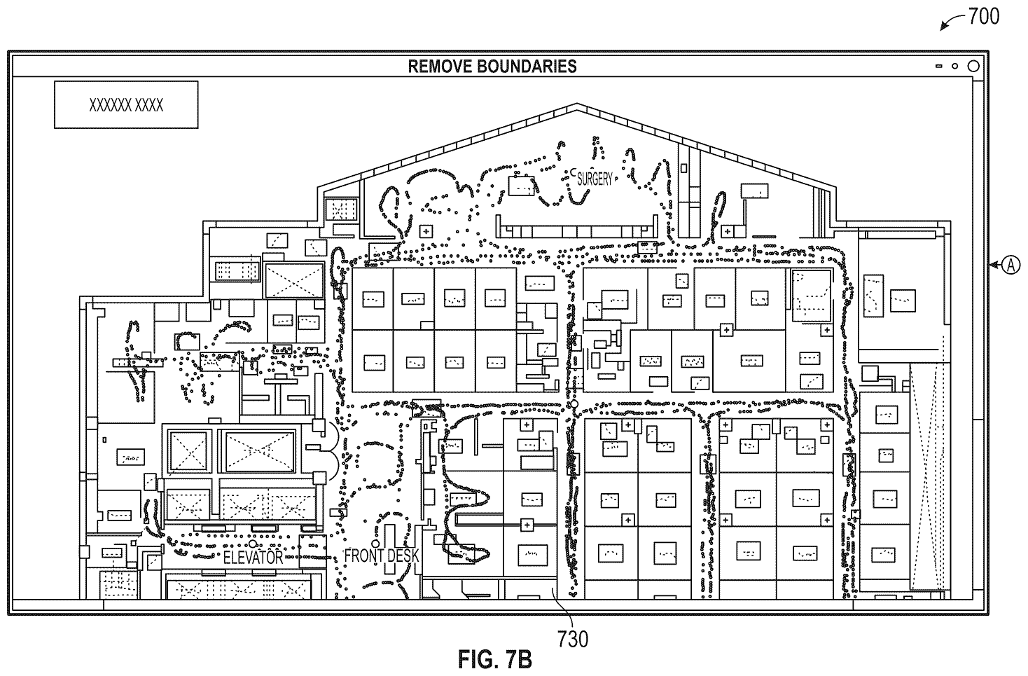

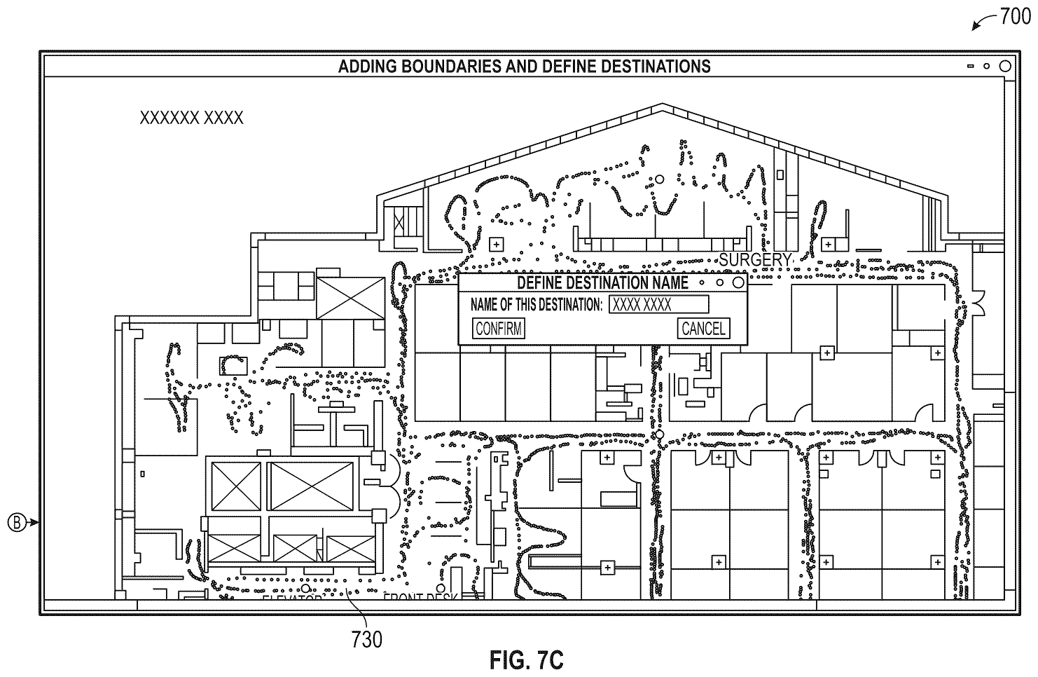

Referring to FIGS. 7A-7C, a user interface 700 is displayed. The user interface 700 includes information associated with generating boundaries on the topometric map 300. By way of example, the user interface 700 includes a map display element 705, a map information element 710, and a saving element 715. The map display element 705 is configured to display the topometric map 300 including the locations of each reference of the reference image database, shown as reference locations 720, and the locations of one or more destinations 725 (e.g., destination 325, potential destinations, exits, stairwells, elevator locations, etc.). A user may interact with the user interface 700 (e.g., the map display element 705) to open a pop-up menu 730 to be displayed by the user interface 700. The pop-up menu 730 may be an enlarged view of the topometric map 300. In some embodiments, boundaries in the pop-up menu 730 (e.g., the boundaries established by the navigation unit 235) can be created, edited, and/or deleted. In some embodiments, a user can create, edit, and/or delete boundaries by drawing on the user interface 700 (e.g., with their finger, with a stylus, with a mouse, etc.). In such embodiments, the boundaries may be virtual boundaries such that the path 320 is established within the navigable areas and avoids the virtual boundaries (e.g., even if a physical boundary is not present where the virtual boundary is established. In some embodiments, the boundaries and/or the navigable areas may be assigned an identifier (e.g., named by the user). The map information element 710 may display information associated with the topometric map 300. By way of example, a user may select a boundary, a navigable space, a destination 725, and/or any other element of the topometric map 300 displayed in the map display element 705, and the map information element 710 may display information associated with the selected element. The saving element 715 may display buttons relating to saving the changes made to the topometric map 300. In some embodiments, the user interface 700 can be provided to a display device (e.g., user device 105). The controller 200 may receive commands from the user device 105 responsive to inputs to the user interface 700 by the user (e.g., button presses, screen taps, requests to perform mapping/localization/navigation operations, etc.). The controller 200 may transmit a signal to the navigation unit 235 commanding the navigation unit 235 to update the path 320 based on any changes (e.g., saved changes) to the boundaries and/or navigable areas input to the user interface 700. In some embodiments, the user interface 400 and the user interface 700 can be included within a single user interface (e.g., the user interfaces are combined).

The system 100 can be installed on any internet accessible device (e.g., the user device 105) and/or can be operated by a cloud-based server (e.g., server 110). In some embodiments, the system 100 supports offline computation of the methods described herein. By way of example, the processes and methods performed by the mapping unit 225, the localization unit 230, and/or the navigation unit 235 may be performed by a controller (e.g., controller 200) of the user device 105 when the user device 105 is unable to connect to the network 120. In some embodiments, one or more of the processes and methods performed by the mapping unit 225, the localization unit 230, and/or the navigation unit 235 may be performed with and/or without a network connection. By way of example, one or more floor plans 310 may be transmitted (e.g., to the controller 200) via the network 120 and the various processes and methods performed by the mapping unit 225, the localization unit 230, and/or the navigation unit 235 may be performed without a connection to the network 120. In some embodiments, the localization of the user by the system 100 becomes more accurate as the user navigates along the path 320 towards the destination 325 because the system 100 and the localization method 500 is based on VPR, which determines reference images from the reference image database that are similar to the query image, thereby increasing the probability of successfully retrieving reference images similar to the query image.

According to an exemplary embodiment, the system 100 may be implemented into an application (e.g., mobile application, virtual application, etc.) to create floor plans (e.g., floor plan 310), sparse maps (e.g., sparse map 315), and/or topometric maps (e.g., topometric map 300) for outdoor environments. In such an embodiment, the system 100 utilizes substantially similar processes and methods performed by the mapping unit 225, the localization unit 230, and/or the navigation unit 235. For use in an outdoor environment, the system 100 may facilitate the navigation of a user along a street, along a sidewalk, into/out of buildings, across streets, etc. The system 100 may facilitate the transition between outdoor and indoor navigation to address the inaccuracies associated with GPS signals (e.g., caused by signal interference in dense urban areas, solar storms, system quality, malfunctioning sensors, etc.). By way of example, the system 100 may facilitate generating floor plans (e.g., visual representations, blue prints, etc.) for use in outdoor environments (e.g., detailing spatial arrangement of rooms, corridors, structural elements, etc.). In some embodiments, the system 100 may operate on scales having varying sizes, such that the generated floor plans may define different sizes (e.g., areas).

For use in an outdoor environment and/or for use in a handoff scenario between an outdoor environment and an indoor environment, the mapping unit 225 of the system 100 may operate substantially similarly as described above. By way of example, the mapping unit 225 is configured to generate the topographic map of an outdoor environment based on vision data (e.g., image/video/LIDAR data captured by a camera/sensor operatively coupled to the user device 105) received as an input. The mapping unit 225, as described in greater detail above, may extract one or more descriptors from the vision data, calculate a direction associated with one or more reference images of the image data, and generate a sparce map of the outdoor environment. The mapping unit 225 may project the generated sparce map onto a two-dimensional map (e.g., floor plan 310) associated with the outdoor environment to create the topometric map. In such an embodiment, the two-dimensional map may include map data received from (e.g., transmitted to the mapping unit 225 via the network 120) an outdoor mapping database (e.g., Google Maps, OpenStreetMap, etc.).

Similarly, for use in an outdoor environment and/or for use in a handoff scenario between an outdoor environment and an indoor environment, the localization unit 230 of the system 100 may operate substantially similarly as described above. By way of example, the localization unit 230 is configured to determine (e.g., localize, compute, identify, etc.) a location and a direction (e.g., orientation) associated with a query image, wherein the location and direction associated with the query image are representative of a location and a direction of a user who captured the query image using the user device 105.

Similarly, for use in an outdoor environment and/or for use in a handoff scenario between an outdoor environment and an indoor environment, the navigation unit 235 of the system 100 may operate substantially similarly as described above. By way of example, the navigation unit 235 is configured to compute, based on the location and the direction associated with the query image determined by the localization unit 230, a path (e.g., route, course, line, etc.) through the outdoor environment (e.g., along a street, along a sidewalk, into/out of buildings, across streets, etc.) to a desired destination. In such an embodiment, the boundaries, as described above, determined by the navigation unit 235 may be based on the received map data from an outdoor mapping database. By way of example, the navigation unit 235 may associate and establish the edges of streets as boundaries. By way of another example, navigation unit 235 may associate and establish corners/walls of buildings as boundaries. In some embodiments, the boundaries may be created, edited, and/or deleted by a user (e.g., virtual boundaries established via the user interface 700). The navigation unit 235 may be further configured to determine a hazard (e.g., a car, a halt sign, a stop sign, a construction site, etc.) along the computed path based on the received query image representative of the location and orientation of the user. The navigation unit 235 may then compute a new path and provide instructions to the user that avoids the hazard. By way of example, the navigation unit 235 may provide an instruction to the user alerting the user to stop moving in response to a determination, based on the query image, that the user is approaching a hazard and/or boundary. By way of another example, the navigation unit 235 may provide an instruction to the user alerting the user to turn left to avoid an oncoming hazard such as a construction site, a pedestrian, a red light, etc.

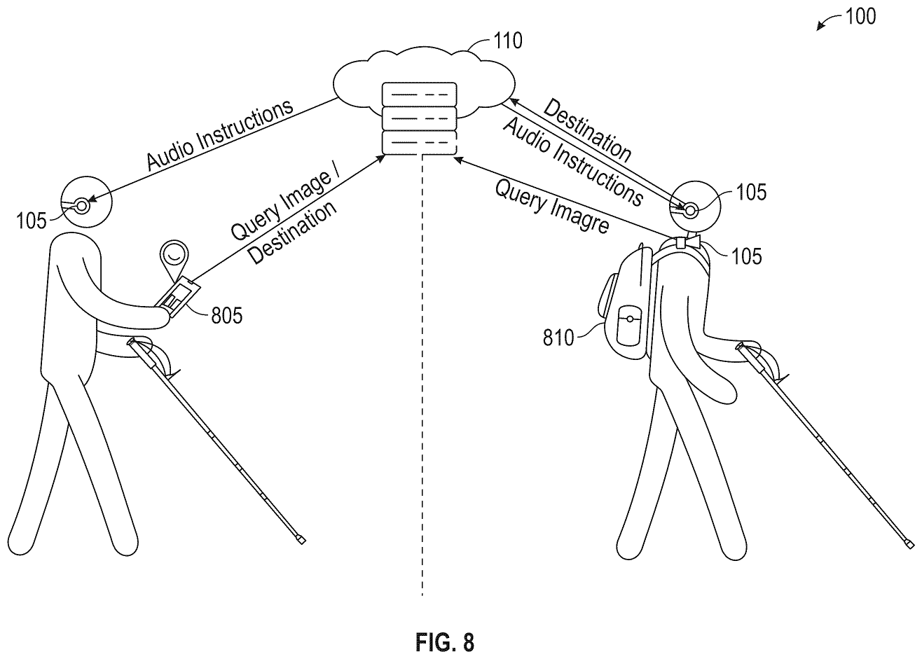

Referring to FIG. 8, the system 100 may be implemented help facilitate the navigation of a user through a space and/or an outdoor environment. In some embodiments, the user may have a visual impairment, cognitive impairment, social impairment, and/or any other disability. In other embodiments, the user may be a pedestrian seeking a more secure and safer journey in an unknown location. By way of example, hospitals may be very large including many different buildings, wings, departments, floors, rooms, etc., thereby making it difficult for the user unfamiliar with the hospital to navigate therethrough. To help the user navigate to a desired location (e.g., to help a patient navigate to a room, to help a new doctor navigate to an operating room, etc.), the system 100 localizes the user in the space and guides the user to the desired location. The left side of FIG. 8 shows a first embodiment of the implementation of the system 100, wherein a query image is captured using the user device 105 embodied as a smartphone 805. In other embodiments, the user device 105 may be a tablet, a laptop, and/or any other device capable of recording and/or transmitting image data. The right side of FIG. 8 shows a second embodiment of the implementation of the system 100, wherein a query image is captured using the user device 105 embodied as a backpack 810 operably coupled to a camera. In other embodiments, the user device 105 may be any other wearable device such as a smartwatch, smart glasses, and/or any other device capable of recording and/or transmitting vision data. The query image may be representative of a location and orientation of the user within the indoor space and/or the outdoor space. The user device 105 may transmit a signal associated with the vision data of the query image to the server 110 via the network 120. The user device 105 may additionally transmit a signal associated with a desired destination (e.g., destination 325, destination 725, etc.). In some embodiments, the user may manually enter the desired destination into a user interface (e.g., user interface 400, user interface 700, etc.) of the user device 105. In other embodiments, the user may audibly orate the desired destination and the user device 105 can interpret the oration and transmit the signal associated with the desired destination. In some embodiments, a cloud device (e.g., the server 110) includes the mapping unit 225, the localization unit 230, and/or the navigation unit 235 and is configured to facilitate (e.g., implement, run, start, etc.) the various mapping, localization, and/or navigation processes as described above. In such an embodiment, after processing the received query image and destination signals, the server 110 may transmit a signal associated with navigation instructions to the user device 105. In response to receiving the signal associated with navigation instructions, one or more user devices 105 may produce at least one of an audible feedback, haptic feedback, and/or visual feedback. The audible feedback, haptic feedback, and/or visual feedback may provide navigation instructions that help facilitate the navigation of the user through the indoor space and/or the outdoor space. By way of example, the user device 105 may include a speaker, earbuds, headphones, etc. configured to, in response to receiving the signal associated with navigation instructions, audibly dictate instructions to the user as the user navigates through the indoor space and/or the outdoor space along the path 320 to the destination. By way of another example, the user device 105 may include a wearable haptic device (e.g., a binaural bone-conduction headset) configured to, in response to receiving the signal associated with navigation instructions, provide haptics (e.g., vibrate, shake, move, etc.), indicative of navigation instructions, to the user as the user navigates through the indoor space and/or the outdoor space along the path 320 to the destination. In some embodiments, one or more of the various mapping, localization, and/or navigation processes as described above may be performed locally on an edge device (e.g., by the user device 105).

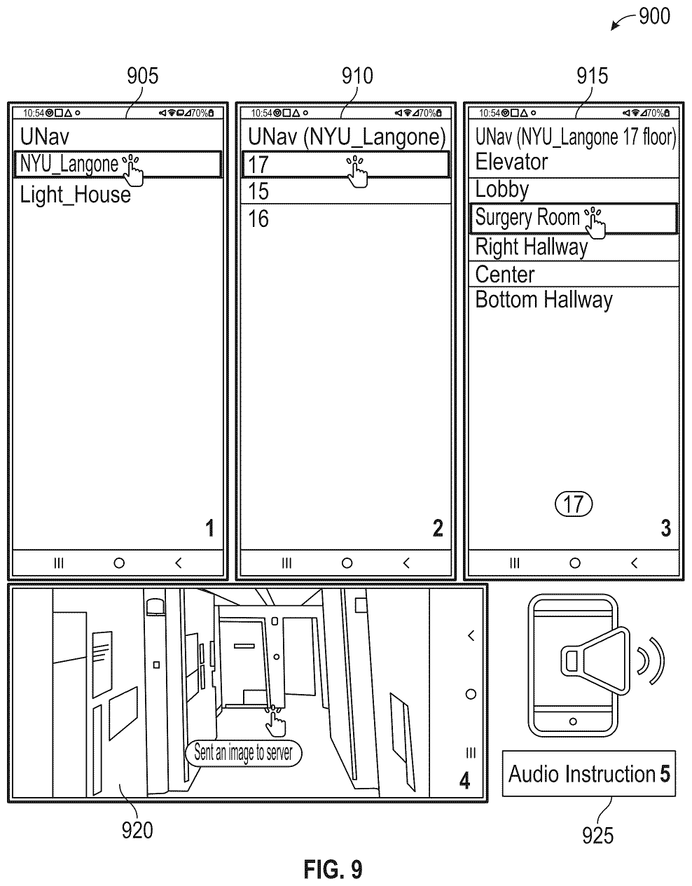

Referring to FIG. 9, a user interface 900 is displayed. The user interface 900 includes information associated with an mobile application included on the user device 105. The user interface 900 is shown in FIG. 9 segmented into five steps. The user interface 900 may display each step individually or all steps simultaneously. Step 905, step 910, and step 915 relate to selecting a desired destination. Step 905, step 910, and step 915 may be completed using a verbal input and/or a tactile input (e.g., interaction) with the user device 105. At step 905, a particular building may be selected, at step 910, a particular floor of the building selected at step 905 may be selected, and at step 915, a desired destination on the floor selected at step 910 may be selected. Completing steps 905-915 sets the desired destination. Once the destination is set, at step 920, the user interface 900 displays a view of (e.g., vision data captured by) a camera operatively coupled with (e.g., included in) the user device 105. At step 920 the user device 105 captures (e.g., via the camera) the query image and transmits a signal to the controller 200 associated with vision data of the query image. The controller 200 receives the signal and performs the various mapping, localization, and/or navigation processes as described above (e.g., locally on the user device 105, by a cloud-based server, etc.). At step 925, the user interface 900 displays an indication that the user device 105 is producing at least one of an audible feedback, haptic feedback, and/or visual feedback. As discussed in greater detail above, the feedback produced by the user device 105 and provided to the user facilitates user navigation through the indoor space and/or the outdoor space to the desired destination. In some embodiments, the system 100 is configured to intermittently capture a new query image as the user navigates through the space and/or outdoor environment to the desired location. In such an embodiment, the new query image may be automatically transmitted to the controller 200 to be processed to determine the location and orientation associated with the new query image.

According to an exemplary embodiment, the system 100, apparatuses (e.g., user device 105), and methods (e.g., localization method 500) described herein for facilitating mapping of a space and/or an outdoor environment, localization of a within the space and/or outdoor environment, and navigation through the indoor space and/or the outdoor space based on a received query image may be implemented by the vision agents 106 to facilitate autonomous navigation thereof through the indoor space and/or the outdoor space. By way of example, the vision agents 106 may include an image capture device capable of recording vision data. The vision agents 106 may be configured to capture a query image and transmit a signal indicative of the vision data representative of a location and an orientation of the vision agents 106 within the indoor space and/or the outdoor space to a controller (e.g., controller 200). In some embodiments, the controller is included on the vision agents 106 and is configured to process the query image locally. In other embodiments, the controller is a cloud-based controller and/or server. The controller may perform one or more of the various mapping, localization, and/or navigation processes as described above to facilitate, based on the query image, navigation of the drone through the indoor space and/or the outdoor space.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

While various units and/or circuits with particular functionality are shown in FIGS. 1-3, it should be understood that the controller 200 may include any number of circuits for completing the functions described herein. For example, the activities and functionalities of the control system 220 may be combined in multiple circuits or as a single circuit. Additional circuits with additional functionality may also be included. Further, the controller 200 may further control other activity beyond the scope of the present disclosure.

As mentioned above and in one configuration, the “circuits” of the controller 200, user device 105, server 110 or smart devices may be implemented in machine-readable medium for execution by various types of processors. An identified circuit of executable code may, for instance, include one or more physical or logical blocks of computer instructions, which may, for instance, be organized as an object, procedure, or function. Nevertheless, the executables of an identified circuit need not be physically located together, but may include disparate instructions stored in different locations which, when joined logically together, form the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set, or may be distributed over different locations including over different storage devices, and may exist, at least partially, merely as electronic signals on a system or network.

While the term “processor” is briefly defined above, the term “processor” and “processing circuit” are meant to be broadly interpreted. In this regard and as mentioned above, the “processor” may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example, the one or more processors may be a remote processor (e.g., a cloud-based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can include RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

Although this description may discuss a specific order of method steps, the order of the steps may differ from what is outlined. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps, and decision steps.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

1. A navigation system comprising:
one or more processing circuits configured to:
process vision data of a space;
generate, based on the vision data, a map of the space;
receive a query image of the space;
compare a feature of the query image with one or more features of the vision data to generate a comparison between the query image and the vision data;
determine, based on the comparison between the query image and the vision data, a location and a direction associated with the query image within the space;
associate the location and the direction associated with the query image with a position and an orientation within the map; and
compute, based on the position and the orientation within the map, a path through the space to a destination.

2. Navigation system of claim 1, wherein the vision data includes a plurality of reference images stored in a reference image database, each reference image of the plurality of reference images associated with a location within the space.

3. Navigation system of claim 2, wherein the one or more processing circuits are configured to generate a three dimensional map of the space based on the plurality of reference images and the locations associated therewith.

4. The navigation system of claim 3, wherein the one or more processing circuits are configured to extract descriptors from the plurality of reference images and calculate a direction of each reference image of the plurality of reference images to generate the three dimensional map.

5. The navigation system of claim 4, wherein the map is a topometric map, and wherein the one or more processing circuits are configured to correspond three dimensional coordinates associated with the descriptors to two dimensional coordinates of a floor plan of the space to generate the topometric map of the space.

6. The navigation system of claim 5, wherein the query image is added to the reference image database as a reference image.

7. The navigation system of claim 1, wherein the comparison between the query image and the vision data is generated by calculating a Euclidean distance and a similarity score between the feature of the query image and the one or more features of the vision data.

8. Navigation system of claim 7, wherein reference images of the vision data determined by the one or more processing circuits, based on the comparison, to be similar to the query image are selected as candidate images.

9. The navigation system of claim 8, wherein the one or more processing circuits are configured to determine, based on known positions and orientations of the candidate images, the location and the direction associated with the query image within the space.

10. The navigation system of claim 1, wherein the one or more processing circuits are configured to:
identify a network characteristic associated with the query image, the network characteristic indicative of the location and the direction associated with the query image within the space; and
determine, based on (i) the comparison between the query image and the vision data and (ii) the network characteristic, the location and the direction associated with the query image within the space.

11. The navigation system of claim 10, wherein the one or more processing circuits are configured to disregard a reference image of the vision data determined to be similar to the query image when the one or more processing circuits determine, based on the network characteristic, that a location of the reference image is geographically dissimilar from the location of the query image within the space.

12. The navigation system of claim 1, wherein the query image is captured by a user device of a user, and wherein the location and the direction associated with the query image is indicative of a location and a direction of the user within the space.

13. The navigation system of claim 12, wherein the one or more processing circuits are configured to provide instructions, by the user device, regarding the path through the space to the destination, wherein the instructions include at least one of an audible feedback, a haptic feedback, or a visual feedback.

14. The navigation system of claim 1, wherein the path includes a first section of the path to a location of a reference image that is closest to the location associated with the query image and a second section of the path from the location of the reference image to the destination.

15. The navigation system of claim 1, wherein the vision data is captured by a sensor of at least one of a user device or a vision agent.

16. The navigation system of claim 15, wherein the vision agent includes an aerial drone, a ground vehicle, a robotic quadruped, or a robotic biped.

17. The navigation system of claim 15, wherein the one or more processing circuits includes at least one of (i) a first processing circuit located on the user device or the vision agent or (ii) a second processing circuit located remote from the user device or the vision agent.

18. The navigation system of claim 1, wherein the space includes at least one of an indoor space or an outdoor space.

19. A navigation system comprising:
a first sensor configured to acquire vision data of a space;
a user device including a second sensor configured to acquire a query image associated with a location and a direction that are indicative of a location and a direction of a user within the space;
one or more processing circuits configured to:
generate, based on the vision data, a map of the space;
receive, from the user device, the query image of the space;
compare a feature of the query image with features of one or more reference images of the vision data to generate a comparison between the query image and the one or more reference images;
determine, based on the comparison between the query image and the one or more reference images, the location and the direction associated with the query image within the space;
associate the location and the direction associated with the query image with a position and an orientation within the map; and
compute, based on the position and the orientation within the map, a path through the space to a destination.

20. A method for environment mapping and navigation, the method comprising:
processing vision data of a space;
generating, based on the vision data, a map of the space;
comparing a feature of a query image associated with a location and a direction within the space with features of a reference image of the vision data to generate a comparison between the query image and the reference image;
determining, based on the comparison between the query image and the reference image, the location and the direction associated with the query image within the space;
associating the location and the direction associated with the query image with a position and an orientation within the map; and
computing, based on the position and the orientation within the map, a path through the space to a destination.
